(19) United States
(12) Patent Application Publication
(10) Pub. No.: US 2017/0200927 A1
(43) Pub. Date: Jul. 13, 2017

(54) CELL MODULE

(71) Applicant: Panasonic Intellectual Property Management Co., Ltd., Osaka (JP)

(72) Inventor: TAKASHI HASEGAWA, Osaka (JP)

(73) Assignee: Panasonic Intellectual Property Management Co., Ltd., Osaka (JP)

(21) Appl. No.: 15/315,440

(22) PCT Filed: Sep. 16, 2015
(86) PCT No.: PCT/JP2015/004722

§ 371 Date: Dec. 1, 2016

(30) Foreign Application Priority Data
Sep. 25, 2014 (JP) 2014-195429

(51) Int. Cl. H01M 2/10; H01M 2/20

(52) U.S. Cl. CPC H01M 2/1077; H01M 2/206; H01M 2220/20

(57) ABSTRACT

A first battery block includes a plurality of cells held in a first battery holder. A second battery block includes a plurality of cells held in a second battery holder. In a plan view from the longitudinal direction of the cells, the first battery holder and the second battery holder are disposed so as to be adjacent to each other. The first line formed by interconnecting the center points of the cells disposed on the second battery holder side, of the plurality of cells held in the first battery holder, is parallel with the second line formed by interconnecting the center points of the cells disposed on the first battery holder side, of the plurality of cells held in the second battery holder.

### TECHNICAL FIELD

The present invention relates to a battery module.

### BACKGROUND ART

As a power source for driving a motor of an electric car or the like, or as a power source for household use or industrial use, a battery module is employed whose charge capacity and output voltage are increased by interconnecting many cells in parallel or in series. A battery block is formed by interconnecting a plurality of cells in parallel, and a battery module is formed by interconnecting a plurality of battery blocks in parallel or in series.

The output current can be increased by increasing the number of cells interconnected in parallel, and the output voltage can be increased by increasing the number of cells interconnected in series.

Patent Literature 1 discloses a battery module in which a plurality of unit cells are stored in a metal battery holder. The plurality of unit cells are stored in cell storage portions that are arranged in a staggered format.

### CITATION LIST

### Patent Literature

PTL 1: International Patent Publication No. 2012/073399

### SUMMARY OF THE INVENTION

In a battery module, the increase in capacity per unit volume is required. In the case of the battery module of Patent Literature 1, a part having no cell storage portion becomes a dead space.

The present invention provides a battery module in which the battery capacity per unit volume is increased.

A battery module of the present invention includes a first battery block and a second battery block. The first battery block includes a first battery holder having a plurality of through holes, and a plurality of cells held in the first battery holder. The second battery block includes a second battery holder having a plurality of through holes, and a plurality of cells held in the second battery holder. In a plan view from the longitudinal direction of the cells, the first battery holder and the second battery holder are disposed so as to be adjacent to each other. The plurality of cells held in the first battery holder are arranged in a staggered format. The plurality of cells held in the second battery holder are arranged in a staggered format. The first line formed by interconnecting the center points of the cells disposed on the second battery holder side, of the plurality of cells held in the first battery holder, is parallel with the second line formed by interconnecting the center points of the cells disposed on the first battery holder side, of the plurality of cells held in the second battery holder.

In the present invention, the capacity per unit volume of the battery module can be achieved.

### BRIEF DESCRIPTION OF DRAWINGS

FIG. 1 is a perspective view showing the appearance of a battery module in accordance with a first exemplary embodiment.

FIG. 2 is an exploded perspective view of a battery block in accordance with the first exemplary embodiment.

FIG. 3 is a top view of the battery module in accordance with the first exemplary embodiment.

FIG. 4 is another top view of the battery module in accordance with the first exemplary embodiment.

FIG. 5 is a perspective view showing the appearance of a battery module in accordance with a second exemplary embodiment.

FIG. 6 is an exploded perspective view of a battery block in accordance with the second exemplary embodiment.

FIG. 7 is a top view of the battery module in accordance with the second exemplary embodiment.

FIG. 8 is a partial perspective view of the configuration constituting the battery module in accordance with the second exemplary embodiment.

FIG. 9 is a partial top view of the configuration constituting the battery module in accordance with the second exemplary embodiment.

FIG. 10 is a partially exploded perspective view of the configuration constituting the battery module in accordance with the second exemplary embodiment.

FIG. 11 is a perspective view for illustrating a modified example of the battery module.

FIG. 12 is a top view for illustrating the modified example of the battery module.

### DESCRIPTION OF EMBODIMENTS

Hereinafter, the examples of the exemplary embodiments of the present invention are specifically described with reference to the accompanying drawings. In the referred drawings, duplicate description of substantially the same component is sometimes omitted.

### First Exemplary Embodiment

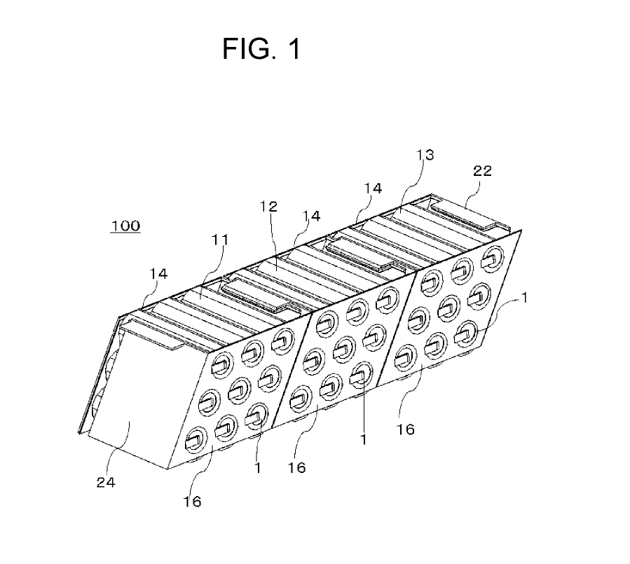

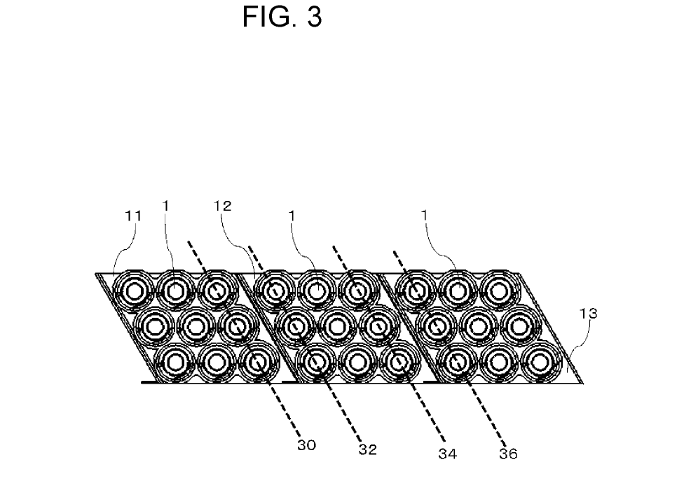

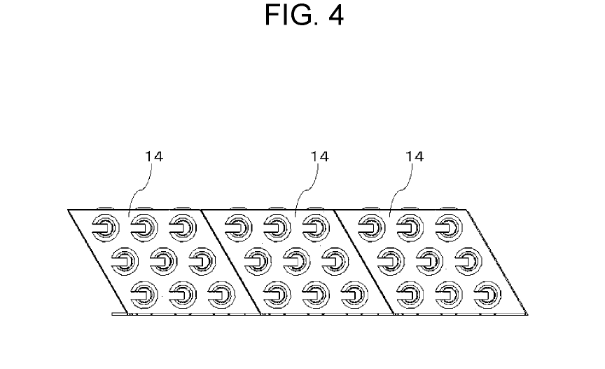

The first exemplary embodiment is described using FIG. 1 to FIG. 4. Both of FIG. 3 and FIG. 4 are top views of a battery module. Cells 1 are exposed in FIG. 3, and a positive electrode current collector is exposed in FIG. 4.

Battery block 10 is formed by interconnecting a plurality of cells 1 in parallel. Battery module 100 is formed by interconnecting a plurality of battery blocks 10 in series.

Battery block 10 includes one battery holder and a plurality of cells 1. In the first exemplary embodiment, nine cells 1 are combined with one battery holder to form a battery block. In the battery holder, nine cells 1 are held while the positive electrodes of cells 1 are aligned to one side and the negative electrodes of cells 1 are aligned to the other side.

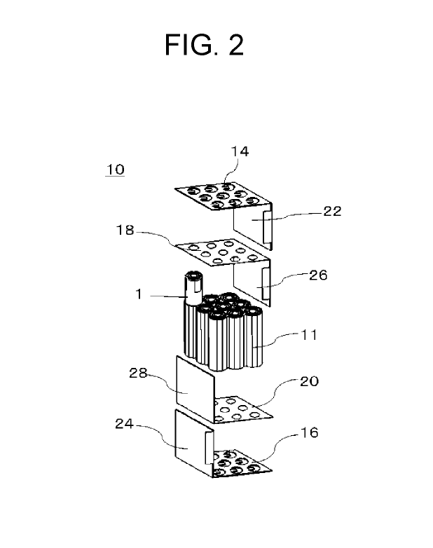

A plurality of cells 1 in each battery block 10 are held in each battery holder. In the first exemplary embodiment, the plurality of cells 1 are held in each of three battery holders. The three battery holders include first battery holder 11, second battery holder 12, and third battery holder 13. FIG. 2 shows an exploded perspective view of battery block 10 using first battery holder 11, but first battery holder 11 may be replaced with second battery holder 12 or third battery holder 13.

Each battery holder is molded of a material of a high thermal conductivity to heat-equalize the plurality of cells 1. The battery holder is molded, by extrusion molding, of a metal mainly made of aluminum for example. The battery holder includes a plurality of through holes for holding the plurality of cells 1. The plurality of through holes are arranged in a staggered (zigzag) format (in a manner of log pile). Cells 1 held in the battery holder are also arranged in a staggered format.

Each cell 1 is a chargeable/dischargeable secondary cell. As the secondary cell, a cylindrical lithium-ion cell is assumed. As cell 1, in addition to the lithium-ion cell, a nickel-metal-hydride cell, alkaline cell, or sodium cell may be employed.

Each battery block 10 includes first positive-electrode current collector 14 on the positive electrode side of cells 1, and first negative-electrode current collector 16 on the negative electrode side of cells 1. First positive-electrode current collector 14 is connected to the positive electrode side of cells 1 via a lead terminal or the like. First negative-electrode current collector 16 is connected to the negative electrode side of cells 1 via a lead terminal or the like. First positive-electrode current collector 14 and first negative-electrode current collector 16 electrically interconnect, in parallel, the plurality of cells 1 included in one battery block.

Positive-side insulating component 18 is disposed between the battery holder and first positive-electrode current collector 14, and electrically insulates them from each other. Negative-side insulating component 20 is disposed between the battery holder and first negative-electrode current collector 16, and electrically insulates them from each other.

In positive-side insulating component 18 and negative-side insulating component 20, portions corresponding to the electrodes of cells 1 are open. First positive-electrode current collector 14 is electrically connected to the positive electrode side of cells 1 via the opening portions in positive-side insulating component 18. First negative-electrode current collector 16 is electrically connected to the negative electrode side of cells 1 via the opening portions in negative-side insulating component 20.

Battery module 100 includes a plurality of battery blocks 10. The plurality of battery blocks 10 are disposed so that the positive electrodes of cells 1 are aligned to one side and the negative electrodes of cells 1 are aligned to the other side.

In order to connect adjacent battery blocks to each other in series, first positive-electrode current collector 14 has positive-side connection plate 22, and first negative-electrode current collector 16 has negative-side connection plate 24. Positive-side connection plate 22 of one battery block is electrically connected to negative-side connection plate 24 of its adjacent battery block. An insulating distance is secured between first positive-electrode current collectors 14 disposed in adjacent battery blocks, in order to prevent the current collectors from coming into contact with each other. An insulating distance is secured between first negative-electrode current collectors 16 disposed in adjacent battery blocks, in order to prevent the current collectors from coming into contact with each other.

Positive-side insulating component 18 includes extending portion 26. In order to prevent positive-side connection plate 22 from coming into contact with first battery holder 11, extending portion 26 is disposed between positive-side connection plate 22 and first battery holder 11. Negative-side insulating component 20 includes extending portion 28. In order to prevent negative-side connection plate 24 from coming into contact with first battery holder 11, extending portion 28 is disposed between negative-side connection plate 24 and first battery holder 11. Positive-side insulating component 18 and negative-side insulating component 20 are required when the material of the battery holder has an electric conductivity. When a resin or the like having no electric conductivity or an extremely low electric conductivity is employed as the material of the battery holder, neither positive-side insulating component 18 nor negative-side insulating component 20 is required. Preferably, the resin has a thermal conductivity. Positive-side insulating component 18 or negative-side insulating component 20 is not always required on respective electrode sides of the cells depending on the insulating state of the cells themselves.

The configuration of a battery block is described.

Cells 1 held in the battery holder are arranged in a staggered format. In a plan view from the longitudinal direction of cells 1, the center points of cells 1 are interconnected.

First line 30 is assumed to be a line that is formed by interconnecting the center points of cells 1 disposed on the second battery holder 12 side, of cells 1 held in first battery holder 11. Second line 32 is assumed to be a line that is formed by interconnecting the center points of cells 1 disposed on the first battery holder 11 side, of cells 1 held in second battery holder 12. First line 30 is parallel with second line 32. Of the outline of first battery holder 11, the portion facing second battery holder 12 has a shape along the outlines of the cells constituting first line 30. Of the outline of second battery holder 12, the portion facing first battery holder 11 has a shape along the outlines of the cells constituting second line 32.

Third line 34 is assumed to be a line that is formed by interconnecting the center points of cells 1 disposed on the third battery holder 13 side, of cells 1 held in second battery holder 12. Fourth line 36 is assumed to be a line that is formed by interconnecting the center points of cells 1 disposed on the second battery holder 12 side, of cells 1 held in third battery holder 13. Third line 34 is parallel with fourth line 36. Of the outline of second battery holder 12, the portion facing third battery holder 13 has a shape along the outlines of the cells constituting third line 34. Of the outline of third battery holder 13, the portion facing second battery holder 12 has a shape along the outlines of the cells constituting fourth line 36.

First line 30 is parallel with the edges on the first battery holder 11 side of first positive-electrode current collector 14 and first negative-electrode current collector 16 that are disposed in second battery holder 12. Second line 32 is parallel with the edges on the second battery holder 12 side of first positive-electrode current collector 14 and first negative-electrode current collector 16 that are disposed in first battery holder 11. Third line 34 is parallel with the edges on the second battery holder 12 side of first positive-electrode current collector 14 and first negative-electrode current collector 16 that are disposed in third battery holder 13. Fourth line 36 is parallel with the edges on the third battery holder 13 side of first positive-electrode current collector 14 and first negative-electrode current collector 16 that are disposed in second battery holder 12.

Here, the parallel state includes a substantially parallel state, namely includes an error in manufacturing.

By forming each battery block in the above-mentioned manner, the dead space in the battery module can be suppressed depending on the relationship between adjacent battery blocks. As the whole battery module, the battery capacity per unit volume can be increased.

### Second Exemplary Embodiment

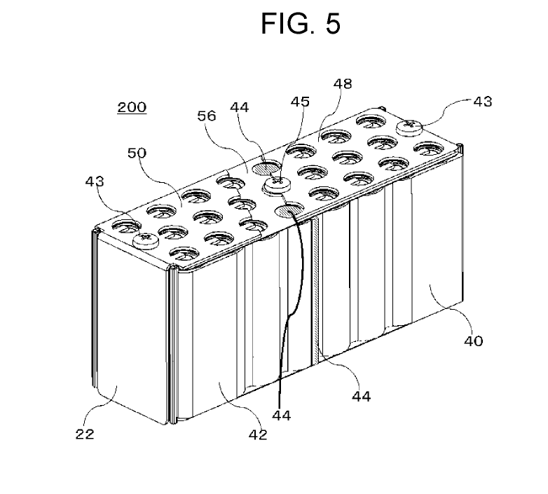

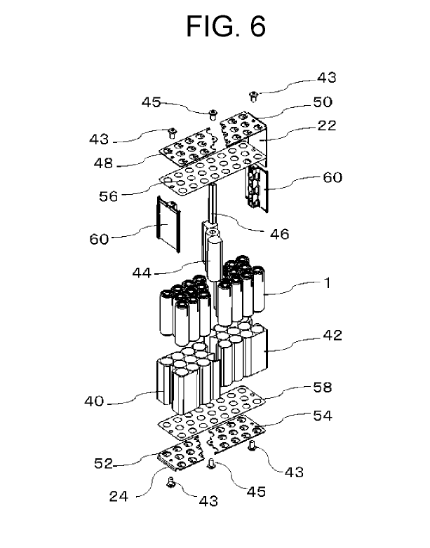

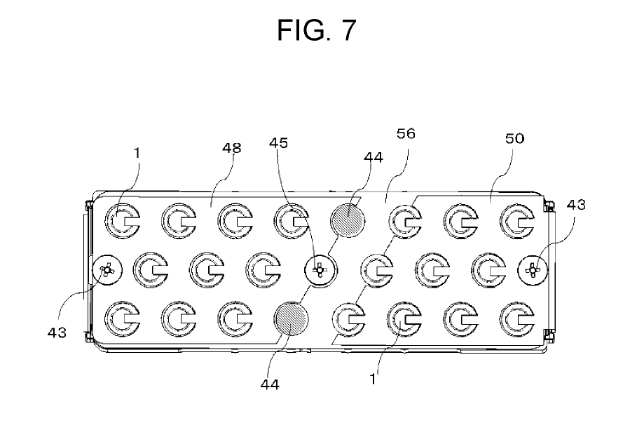

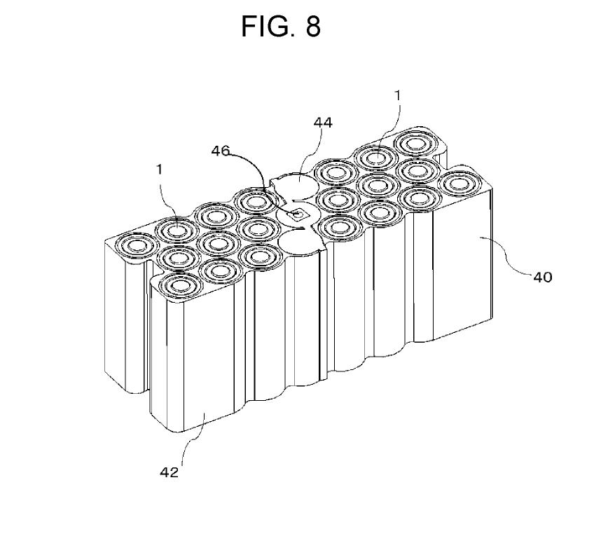

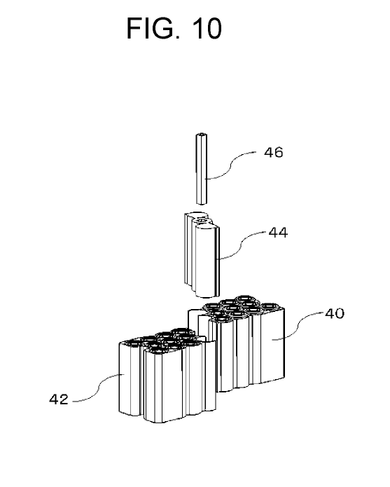

A second exemplary embodiment is described using FIG. 5 to FIG. 10.

A battery block is formed by interconnecting a plurality of cells 1 in parallel. Battery module 200 is formed by interconnecting a plurality of battery blocks in series.

A battery block includes one battery holder and a plurality of cells 1. In the second exemplary embodiment, 10 cells 1 are combined with one battery holder to form a battery block. In the battery holder, 10 cells 1 are held while the positive electrodes of cells 1 are aligned to one side and the negative electrodes of cells 1 are aligned to the other side.

A plurality of cells 1 in each battery block are held in each battery holder. In the second exemplary embodiment, the plurality of cells 1 are held in each of two battery holders. The two battery holders include fourth battery holder 40 and fifth battery holder 42. Battery module 200 is formed of cells 1 held in fourth battery holder 40 and cells 1 held in fifth battery holder 42 while the positive electrodes of the cells are aligned to one side and the negative electrodes of the cells are aligned to the other side.

Each battery holder includes a plurality of through holes to hold a plurality of cells 1. The plurality of through holes are arranged in a staggered format. Cells 1 held in the battery holder are also arranged in a staggered format. The through holes in the battery holder are formed in cylindrical shapes along the outlines of cells 1. In the plan view from the longitudinal direction of the cells, the shapes of the through holes are circles.

Fourth battery holder 40 and fifth battery holder 42 originate from one battery holder. In other words, one battery holder having through holes for holding 23 cells is divided into fourth battery holder 40 for holding 10 cells and fifth battery holder 42 for holding 10 cells. As a method of dividing one battery holder into a plurality of battery holders, a machining process such as a handsaw can be employed.

By forming a plurality of battery holders from one battery holder, the number of types of dies used when the plurality of battery holders are molded can be reduced. In the case of the second exemplary embodiment, a die for a battery holder capable of holding 10 cells is not required, and the same die as the die for a battery holder capable of holding 23 cells can be employed.

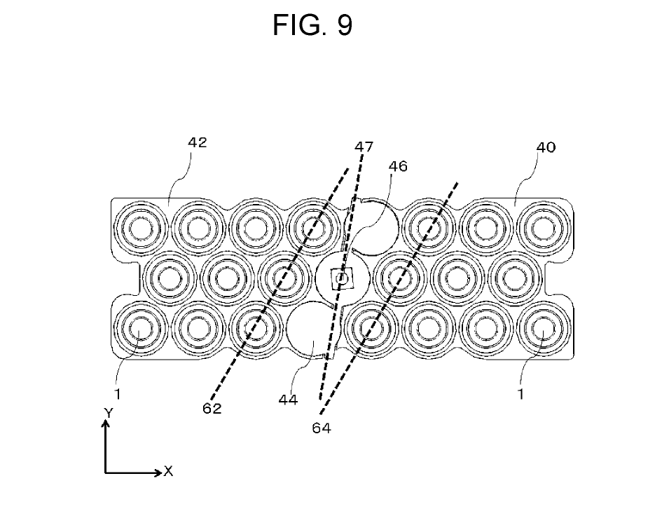

When one battery holder is divided into a plurality of battery holders, in the plan view, the division is performed so as to vertically or horizontally cut through holes. In FIG. 9, the longitudinal direction of the one battery holder is defined as the X direction, and the lateral direction of the one battery holder is defined as the Y direction. In the second exemplary embodiment, the one battery holder is divided so as to be vertically cut in the Y direction.

When one battery holder is divided into a plurality of battery holders, in the plan view, the division is performed so as to cut adjacent through holes in a straight line. In FIG. 9, when three rows of through holes are arranged in the Y direction, the division is performed so as to cut a total of three through holes, namely one through hole on each row, in a straight line. FIG. 9 shows the state where dividing line 47 penetrates the through holes in a straight line.

In FIG. 9, each of the through hole closest to the plus Y side and the through hole closest to the minus Y side is divided into a major arc and a minor arc. When the right side of one through hole is a major arc and the left side thereof is a minor arc, the other through hole is divided so that the right side is a minor arc and the left side is a major arc. Here, the portion whose length is longer than a half of the circumference of a through hole is a major arc, and the portion whose length is shorter is a minor arc.

Insulating connection member 44 is held in the divided through holes. Connection member 44 is used for insulating the battery block including fourth battery holder 40 from the battery block including fifth battery holder 42. The shape of connection member 44 is similar to a shape formed by interconnecting the divided through holes. In the plan view, the configuration is designed in which the length of the portion of connection member 44 that projects from fourth battery holder 40 and fifth battery holder 42 is longer than the creeping distance.

By dividing each of the through holes existing at the ends, of the divided through holes, into a major arc and a minor arc, connection member 44 can be connected to the fourth battery holder and connection member 44 can be connected to the fifth battery holder.

A battery block includes a positive-electrode current collector on the positive electrode side of cells 1, and includes a negative-electrode current collector on the negative electrode side of cells 1. Fourth battery holder 40 includes second positive-electrode current collector 48 and second negative-electrode current collector 52. Fifth battery holder 42 includes third positive-electrode current collector 50 and third negative-electrode current collector 54. The current collectors are attached to insulating components 60 via first bolts 43, and are fixed to the battery blocks. Each positive-electrode current collector is connected to the positive electrode side of aligned and arranged cells 1 via a lead terminal or the like. Each negative-electrode current collector is connected to the negative electrode side of aligned and arranged cells 1 via a lead terminal or the like. The positive-electrode current collector and negative-electrode current collector electrically interconnect, in parallel, the plurality of cells 1 included in one battery block.

Connection member 44 includes conduction member 46. In the plan view, conduction member 46 penetrates connection member 44. Conduction member 46 and conductive second bolt 45 electrically connect second positive-electrode current collector 48 to third negative-electrode current collector 54.

Third positive-electrode current collector 50 includes positive-side connection plate 22. Second negative-electrode current collector 52 includes negative-side connection plate 24. These connection plates are also used for electrically connecting the battery blocks to their adjacent battery blocks (not shown) in series.

Positive-side insulating component 56 is disposed between the battery holders and the positive-electrode current collectors, and electrically insulates the holders from the collectors. Negative-side insulating component 58 is disposed between the battery holders and the negative-electrode current collectors, and electrically insulates the holders from the collectors. Insulating components 60 are disposed for securing the insulation from battery holders that are disposed adjacently to fourth battery holder 40 and fifth battery holder 42.

Fifth line 62 is assumed to be a line that is formed by interconnecting the center points of cells 1 disposed on the fifth battery holder 42 side, of cells 1 held in fourth battery holder 40. Sixth line 64 is assumed to be a line that is formed by interconnecting the center points of cells 1 disposed on the fourth battery holder 40 side, of cells 1 held in fifth battery holder 42. Fifth line 62 is parallel with sixth line 64. Here, the parallel state includes a substantially parallel state, namely includes an error in manufacturing.

One battery block is divided into a plurality of battery blocks, the insulation between the divided battery blocks is performed using the through holes existing in the divided portion. Thus, the dead space can be used depending on the relationship between adjacent battery blocks. Since a conduction member for electrically interconnecting adjacent battery blocks is held in an insulating member, another conduction member is not required to be disposed outside the battery blocks when the battery blocks are insulated from each other. Thus, a more space-saving configuration can be provided.

One battery block is divided into a plurality of battery blocks, the insulation between the divided battery blocks is performed using the through holes existing in the divided portion. An insulating distance can be sufficiently secured between adjacent battery blocks.

As the whole battery module, the battery capacity per unit volume can be increased.

### Modified Example

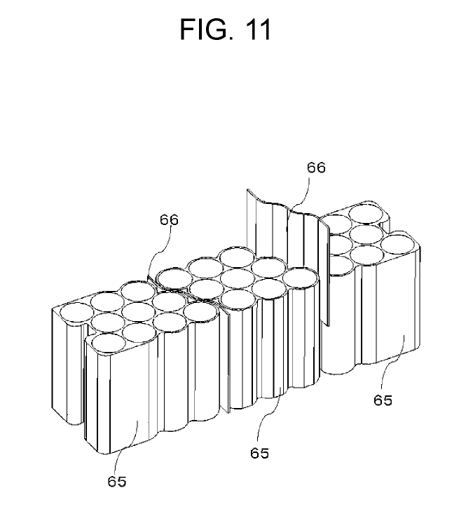

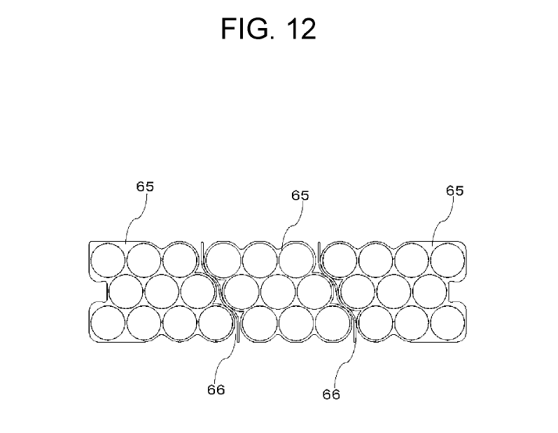

FIG. 11 and FIG. 12 show a modified example. Also in the modified example, similarly to the second exemplary embodiment, one battery holder is divided into a plurality of battery holders. In the modified example, however, the through holes in a divided portion do not leave a mark. An insulating sheet is disposed between adjacent divided battery holders.

In the second exemplary embodiment, using the cut through holes in the divided portion, insulation between adjacent battery blocks is achieved by connection member 44, and conduction between adjacent battery blocks is achieved by conduction member 46. While, when a conduction member is not disposed in the cut through holes in the divided portion, the occurrence of a dead space can be suppressed by employing the configuration of the modified example.

Insulating sheet 66 can be disposed between first battery holder 11 and second battery holder 12 and between second battery holder 12 and third battery holder 13 in the first exemplary embodiment. When adjacent battery blocks are interconnected in series without using positive-side connection plate 22 and negative-side connection plate 24 in the first exemplary embodiment, insulating sheet 66 can be disposed even for the first exemplary embodiment.

### INDUSTRIAL APPLICABILITY

A battery module of the present invention is useful as a power source for driving a motor of an electric car or the like or a backup power source or the like.

### REFERENCE MARKS IN THE DRAWINGS

100, 200 battery module
1 cell
10 battery block
11 first battery holder
12 second battery holder
13 third battery holder
14 first positive-electrode current collector
16 first negative-electrode current collector
18, 56 positive-side insulating component
20, 58 negative-side insulating component
22 positive-side connection plate
24 negative-side connection plate
26, 28 extending portion
30 first line
32 second line
34 third line
36 fourth line
40 fourth battery holder
42 fifth battery holder
43 first bolt
44 connection member
45 second bolt
46 conduction member
47 dividing line
48 second positive-electrode current collector
50 third positive-electrode current collector
52 second negative-electrode current collector
54 third negative-electrode current collector
60 insulating component
62 fifth line
64 sixth line
66 insulating sheet

1. A battery module comprising:
a first battery block including:
a first battery holder having a plurality of through holes; and
a plurality of cells held in the first battery holder; and
a second battery block including:
a second battery holder having a plurality of through holes; and
a plurality of cells held in the second battery holder,
wherein
in a plan view from a longitudinal direction of the plurality of cells held in the first battery holder and the plurality of cells held in the second battery holder,
the first battery holder and the second battery holder are disposed so as to be adjacent to each other,
the plurality of cells held in the first battery holder are arranged in a staggered format,
the plurality of cells held in the second battery holder are arranged in a staggered format, and
a first line formed by interconnecting center points of a plurality of cells disposed on a second battery holder side, of the plurality of cells held in the first battery holder, is parallel with a second line formed by interconnecting center points of a plurality of cells disposed on a first battery holder side, of the plurality of cells held in the second battery holder.

2. The battery module according to claim 1, wherein
the plurality of cells held in the first battery holder and the plurality of cells held in the second battery holder are cylindrical cells.

3. The battery module according to claim 1, wherein
the first battery holder and the second battery holder are molded of a metal mainly made of aluminum.

4. The battery module according to claim 1, wherein
the plurality of cells to be held in the first battery holder are held in the first battery holder while positive electrodes of the plurality of cells are aligned to a first side and negative electrodes of the plurality of cells are aligned to a second side,
a positive-electrode current collector is disposed on the positive electrodes of the plurality of cells, and a negative-electrode current collector is disposed on the negative electrodes of the plurality of cells,
one edge on the second battery holder side of an outline of the positive-electrode current collector is parallel with the second line, and
one edge on the second battery holder side of an outline of the negative-electrode current collector is parallel with the second line.

5. The battery module according to claim 1, wherein
of an outline of the first battery holder, a portion facing the second battery holder has a shape along outlines of the plurality of cells constituting the first line, and
of an outline of the second battery holder, a portion facing the first battery holder has a shape along outlines of the plurality of cells constituting the second line.

6. The battery module according to claim 1, wherein
an insulating sheet is disposed between the first battery holder and the second battery holder.

7. The battery module according to claim 1, wherein
when the first battery holder is brought into contact with the second battery holder, a plurality of circular through holes are formed in the plan view, and
the plurality of circular through holes are disposed so as to vertically or horizontally separate the first battery holder from the second battery holder.

8. The battery module according to claim 7, wherein
a through hole, of the plurality of circular through holes disposed so as to vertically or horizontally separate the first battery holder from the second battery holder, includes a major arc on the first battery holder side and a minor arc on the second battery holder side.

9. The battery module according to claim 8, wherein
the first battery holder includes a major arc and a minor arc, and
the second battery holder includes a major arc and a minor arc.

10. The battery module according to claim 7, wherein
an insulating connection member is disposed between the first battery holder and the second battery holder, and
in the plan view, the connection member has a shape formed by interconnecting circles.

11. The battery module according to claim 10, wherein
in the plan view, the connection member has a portion projecting from the first battery holder and the second battery holder.

12. The battery module according to claim 6, wherein
the plurality of cells to be held in the first battery holder are held in the first battery holder while the positive electrodes of the plurality of cells are aligned to a first side and the negative electrodes of the plurality of cells are aligned to a second side,
a first positive-electrode current collector is disposed on the positive electrodes of the plurality of cells, and a first negative-electrode current collector is disposed on the negative electrodes of the plurality of cells,
the plurality of cells to be held in the second battery holder are held in the second battery holder while positive electrodes of the plurality of cells are aligned to a first side and negative electrodes of the plurality of cells are aligned to a second side,
a second positive-electrode current collector is disposed on the positive electrodes of the plurality of cells, and a second negative-electrode current collector is disposed on the negative electrodes of the plurality of cells,
the connection member includes a conduction member, and
the connection member connects the first positive-electrode current collector to the second negative-electrode current collector.

13. The battery module according to claim 7, wherein
the plurality of cells to be held in the first battery holder are held in the first battery holder while the positive electrodes of the plurality of cells are aligned to a first side and the negative electrodes of the plurality of cells are aligned to a second side,
a first positive-electrode current collector is disposed on the positive electrodes of the plurality of cells, and a first negative-electrode current collector is disposed on the negative electrodes of the plurality of cells,
the plurality of cells to be held in the second battery holder are held in the second battery holder while positive electrodes of the plurality of cells are aligned to a first side and negative electrodes of the plurality of cells are aligned to a second side,
a second positive-electrode current collector is disposed on the positive electrodes of the plurality of cells, and a second negative-electrode current collector is disposed on the negative electrodes of the plurality of cells,
the connection member includes a conduction member, and
the connection member connects the first positive-electrode current collector to the second negative-electrode current collector.
